(19) United States
(12) Patent Application Publication
(10) Pub. No.: US 2020/0410948 A1
(43) Pub. Date: Dec. 31, 2020

(54) GATE DRIVER ON ARRAY (GOA) CIRCUIT AND DISPLAY PANEL

(71) Applicant: WUHAN CHINA STAR OPTOELECTRONICS TECHNOLOGY CO., LTD, WUHAN, HUBEI (CN)

(72) Inventor: Ronglei DAI, WUHAN, HUBEI (CN)

(21) Appl. No.: 16/615,399

(22) PCT Filed: Jan. 8, 2019
(86) PCT No.: PCT/CN2019/070900

§ 371 Date: Nov. 20, 2019

(30) Foreign Application Priority Data
Nov. 30, 2018 (CN) 201811459972.1

(51) Int. Cl. G09G 3/36

(52) U.S. Cl. CPC G09G 3/3677

(57) ABSTRACT

A gate driver on array (GOA) circuit display panel is disclosed and achieves control to a voltage of a leakage path by a gate electrode signal of a seventh thin film transistor in a voltage regulation module. The display panel eliminates a stop leakage path of a touch panel by changing a signal.

### FIELD OF INVENTION

The present invention relates to a field of liquid crystal display technologies, especially to a gate driver on array (GOA) circuit and a display panel.

### BACKGROUND OF INVENTION

A conventional gate driver on array (GOA) technology employs an array process for a conventional thin film transistor liquid crystal display disposes a scan drive signal circuit of rows of gate electrodes on an array substrate to form a scan drive for a liquid crystal display panel. The GOA technology, compared to a conventional chip on flip (COF) technology, not only extremely lowers the manufacturing cost, but also omits a COF bonding process for the gate electrodes, which facilitates a yield rate. Therefore, the GOA technology is an important technology for development of display panels in the future.

### SUMMARY OF INVENTION

### Technical Issue

At present, the mature integrated touch display panel technology is widely used in high-end mobile phones. In the integrated touch display panel, because refresh times of the display panel are separated apart at intervals, the display panel usually implements touch scanning in the intervals (i.e., touch panel stop time) such that a work status of the gate driver on array (GOA) circuit of the display panel is not continuous and a phenomenon of a period of holding status after each scanning of certain stages occurs. However, during the holding status of the GOA circuit, holding ability of the circuit often becomes poor such that stage transfer of the GOA circuit is failed and display errors occur.

Therefore, a GOA optimized circuit is needed for overcoming the issue that the insufficient holding ability of the GOA circuit stopping in the touch panel such that a leakage path of the stopped touch panel is eliminated to achieve a goal of lowering a risk of failure of stage transfer of the GOA circuit and to make the circuit more stable.

### Technical Solution

An objective of the present invention is to provide a gate driver on array (GOA) circuit and a display panel, the circuit and the display panel, by changing a gate electrode signal of a seventh thin film transistor in a voltage regulation module, achieves control of voltage of a leakage path, and by changing the signal, eliminates a stop leakage path of the touch panel.

According to an aspect of the present invention, the present invention provides a GOA circuit, the GOA circuit comprises a plurality of GOA units that are cascaded, wherein when N is a positive integer greater than 2, an Nth stage GOA unit comprises: a forward and reverse scan control module, a node signal control inputting module, a first node pull-down module, a gate electrode signal pull-down module, a global control signal function module, an output control module, a voltage regulation module and a bootstrap capacitor; wherein: the forward and reverse scan control module is configured to control forward scan of the GOA circuit through a forward direct current scan control signal, or control reverse scan of the GOA circuit through a reverse direct current scan control signal; the node signal control inputting module is connected to the forward and reverse scan control module, the first node pull-down module, the gate electrode signal pull-down module, and the global control signal function module, the node signal control inputting module is configured to control low potential output of the GOA circuit; the first node pull-down module is connected to the forward and reverse scan control module, the node signal control inputting module, and the voltage regulation module, and the first node pull-down module is configured to pull down a level of the first node; the gate electrode signal pull-down module is connected to the node signal control inputting module and the output control module, and the gate electrode signal pull-down module is configured to pull down a level of a present-stage gate electrode drive signal and to control output of the present-stage gate electrode drive signal during a touch panel scanning period; the global control signal function module is connected to the node signal control inputting module, the gate electrode signal pull-down module, and the output control module, and the global control signal function module, by a first global control signal and a second global control signal, opens all of the gate electrode drive signal of the GOA circuit and controls the output of the present-stage gate electrode drive signal during the touch panel scanning period; the output control module is connected to the bootstrap capacitor, the global control signal function module, and the gate electrode signal pull-down module, and the output control module is configured to control of the output of the present-stage gate electrode drive signal; the voltage regulation module is connected to the forward and reverse scan control module, the first node pull-down module and the bootstrap capacitor, and the voltage regulation module is configured to maintain a level of a first node; wherein the voltage regulation module comprises a seventh thin film transistor, and a gate electrode of the seventh thin film transistor receives a third global control signal, a source electrode of the seventh thin film transistor is connected to the forward and reverse scan control module and the first node pull-down module, a drain electrode of the seventh thin film transistor is connected to the first node, the third global control signal is a constant voltage high level signal during the touch panel scanning period, and is a constant voltage low potential signal during a touch panel stop period; one of two ends of the bootstrap capacitor is connected to the drain electrode of the first node and the seventh thin film transistor, the other end receives the constant voltage low potential signal, and the bootstrap capacitor is configured to raise the level of the first node two times.

In an embodiment of the present invention, the Nth stage GOA unit further comprises: a second node pull-down module, the second node pull-down module is connected to the forward and reverse scan control module, the node signal control inputting module, and the first node pull-down module, and the second node pull-down module is configured to pull down a level of a second node.

In an embodiment of the present invention, the forward and reverse scan control module comprises a first thin film transistor and a second thin film transistor, a gate electrode of the first thin film transistor is connected to a gate electrode drive signal of a (N−2)th GOA unit, a source electrode of the first thin film transistor receives the forward direct current scan control signal, and a drain electrode of the first thin film transistor is connected to the source electrode of the seventh thin film transistor and a drain electrode of the second thin film transistor; a gate electrode of the second thin film transistor is connected to a gate electrode drive signal of a (N+2)th GOA unit, and a source electrode of the second thin film transistor receives the reverse direct current scan control signal.

In an embodiment of the present invention, the node signal control inputting module comprises a third thin film transistor, a fourth thin film transistor and an eighth thin film transistor, a gate electrode of the third thin film transistor receives the forward direct current scan control signal, a source electrode of the third thin film transistor receives a clock signal of a (N+1)th GOA unit, and a drain electrode of the third thin film transistor is connected to a drain electrode of the fourth thin film transistor and a gate electrode of the eighth thin film transistor; a gate electrode of the fourth thin film transistor receives the reverse direct current scan control signal, and a source electrode of the fourth thin film transistor receives a clock signal of a (N−1)th GOA unit; a source electrode of the eighth thin film transistor receives a constant voltage high potential signal, and a drain electrode of the eighth thin film transistor is connected to a second node that is connected to the first node pull-down module, the second node pull-down module, the gate electrode signal pull-down module, and the global control signal function module.

In an embodiment of the present invention, the output control module comprises a ninth thin film transistor, a gate electrode of the ninth thin film transistor is connected to the first node, a source electrode of the ninth thin film transistor receives a present-stage clock signal, and a drain electrode of the ninth thin film transistor receives the present-stage gate electrode drive signal.

In an embodiment of the present invention, the first node pull-down module comprises a fifth thin film transistor, a gate electrode of the fifth thin film transistor is connected to the second node, a source electrode of the fifth thin film transistor receives the constant voltage low potential signal, a drain electrode of the fifth thin film transistor is connected to the source electrode of the seventh thin film transistor and is connected to the first node through the seventh thin film transistor.

In an embodiment of the present invention, the second node pull-down module comprises a sixth thin film transistor, a gate electrode of the sixth thin film transistor is connected to the drain electrode of the first thin film transistor and the drain electrode of the second thin film transistor in the forward and reverse scan control module, a source electrode of the sixth thin film transistor receives the constant voltage low potential signal, and a drain electrode of the sixth thin film transistor is connected to the second node.

In an embodiment of the present invention, the gate electrode signal pull-down module comprises a tenth thin film transistor, a gate electrode of the tenth thin film transistor is connected to the second node, a source electrode of the tenth thin film transistor receives the constant voltage low potential signal, and a drain electrode of the tenth thin film transistor receives the present-stage gate electrode drive signal.

In an embodiment of the present invention, the global control signal function module comprises an eleventh thin film transistor, a twelfth thin film transistor and a thirteenth thin film transistor, a gate electrode and a source electrode of the eleventh thin film transistor are shorted for receiving the first global control signal, and a drain electrode of the eleventh thin film transistor receives the present-stage gate electrode drive signal; a gate electrode of the twelfth thin film transistor receives the first global control signal, a source electrode of the twelfth thin film transistor receives the constant voltage low potential signal, and a drain electrode of the twelfth thin film transistor is connected to the second node; a gate electrode of the thirteenth thin film transistor receives the second global control signal, a source electrode of the thirteenth thin film transistor receives the constant voltage low potential signal, and a drain electrode of the thirteenth thin film transistor receives the present-stage gate electrode drive signal.

According to another aspect of the present invention, a display panel is provided, and the display panel comprises the GOA circuit.

### Advantages

An advantage of the present invention is that the GOA circuit, by changing the gate electrode signal of the seventh thin film transistor in the voltage regulation module into a non-constant voltage high potential signal and a controllable third global control signal GAS3, and changing a voltage of the third global control signal GAS3 during the touch panel stop period into a constant voltage low potential signal, eliminates a stop leakage path in the touch panel to lower the risk of failure of stage transfer of the GOA circuit and stabilize the circuit. The display panel employing the above GOA circuit also has the above advantage.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a framework diagram of a gate driver on array (GOA) circuit of an embodiment of the present invention.

FIG. 2 is a schematic view of a circuit connection of the GOA circuit of the embodiment of the present invention.

### DETAILED DESCRIPTION OF PREFERRED EMBODIMENTS

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

The specification and claims of the present invention and terminologies “first”, “second”, “third”, etc. (if existing) in the above accompanying drawings are configured to distinguish similar objects and are not configured to describe a specific sequence or order thereof. It should be understood that such described objects can be exchanged with one another in an adequate condition. Furthermore, terminologies “include”, “have” and any variant thereof are intended to inclusive inclusion instead of exclusive inclusion.

In the present patent document, the drawings, which are discussed below, are used to describe the principles of the present invention, are for illustrative purposes only and are not to be construed as limiting the scope of the present invention. It will be understood by a person skilled in the art that the principles of the present invention may be implemented in any suitably arranged system. Exemplary embodiments will be described in detail, and examples of the embodiments are illustrated in the accompanying drawings. Further, a device according to an exemplary embodiment will be described in detail with reference to the accompanying drawings. The same reference numerals in the drawings refer to the same elements.

The terminologies used in the specification of the present invention are only used to describe the specific embodiments, and are not intended to show the concept of the present invention. Unless the context clearly has a different meaning, the expression used in the singular form encompasses the plural form of expression. In the present invention, it should be understood that terminologies such as “comprise”, “have” and “include” are intended to indicate the possibility of the features, numbers, steps, actions or combinations thereof disclosed in the present invention. It is not intended to exclude the possibility that one or a plurality of other features, numbers, steps, actions or combinations thereof may be added. The same reference numerals in the drawings refer to the same parts.

An embodiment of the present invention provides a gate driver on array (GOA) circuit and a display panel. Detailed descriptions will be presented as follows.

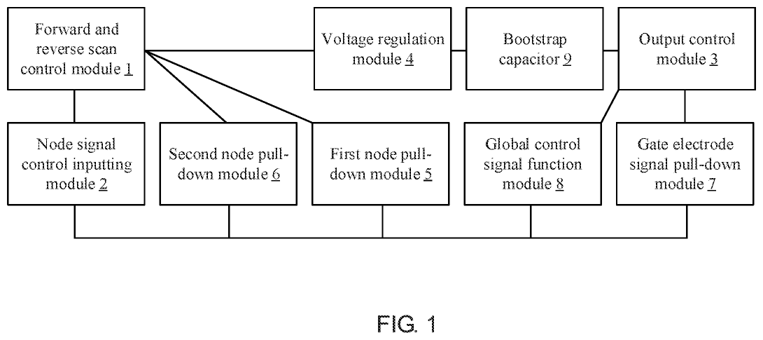

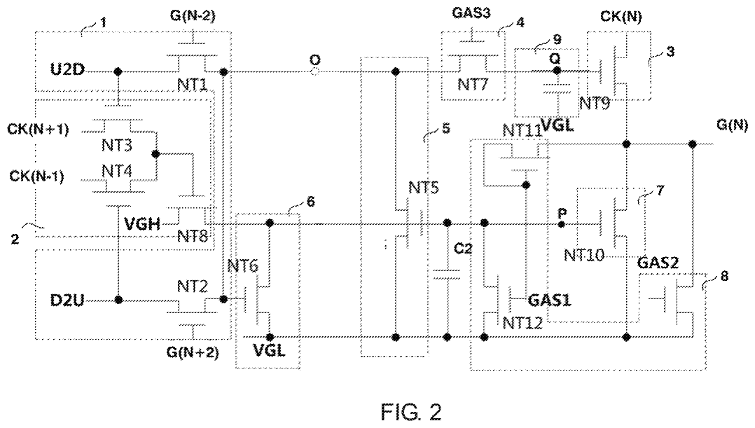

With reference to FIGS. 1 and 2, FIG. 1 is a framework diagram of a gate driver on array (GOA) circuit of an embodiment of the present invention.

FIG. 2 is a schematic view of a circuit connection of the GOA circuit of the embodiment of the present invention.

The present invention provides a GOA circuit, which includes a plurality of GOA units that are cascaded. To more clearly describe the present invention, an Nth stage GOA unit is described in details, and N is a positive integer greater than 2.

With reference to FIG. 1, the Nth stage GOA units includes: a forward and reverse scan control module 1, a node signal control inputting module 2, a first node pull-down module 5, a second node pull-down module 6, a gate electrode signal pull-down module 7, a global control signal function module 8, an output control module 3, a voltage regulation module 4, and a bootstrap capacitor 9.

The forward and reverse scan control module 1 is configured to control forward scan of the GOA circuit through a forward direct current scan control signal, or control reverse scan of the GOA circuit through a reverse direct current scan control signal.

The node signal control inputting module 2 is connected to the forward and reverse scan control module 1, the first node pull-down module 5, the second node pull-down module 6, the gate electrode signal pull-down module 7, and the global control signal function module 8. The node signal control inputting module 2 is configured to control low potential output of the GOA circuit in a non-work status.

The first node pull-down module 5 is connected to the forward and reverse scan control module 1, the node signal control inputting module 2, and the voltage regulation module 4. The first node pull-down module 5 is configured to pull down a level of a first node Q.

The second node pull-down module 6 is connected to the forward and reverse scan control module 1, the node signal control inputting module 2, and the first node pull-down module 5. The second node pull-down module 6 is configured to pull down a level of a second node P.

The gate electrode signal pull-down module 7 is connected to the node signal control inputting module 2 and the output control module 3, and the gate electrode signal pull-down module 7 is configured to pull down a level of a present-stage gate electrode drive signal and to control output of the present-stage gate electrode drive signal during a touch panel scanning period.

The global control signal function module 8 is connected to the node signal control inputting module 2, the gate electrode signal pull-down module 7, and the output control module 3. The global control signal function module 8, by a first global control signal GAS1 and a second global control signal GAS2, achieves switch-on of all of the gate electrode drive signals of the GOA circuit and control of the present-stage gate electrode drive signal G(N) during the touch panel scanning period.

The output control module 3 is connected to the bootstrap capacitor 9, the global control signal function module 8, and the gate electrode signal pull-down module 7, and is configured to control the output of the present-stage gate electrode drive signal.

The voltage regulation module 4 is connected to the forward and reverse scan control module 1. The first node pull-down module 5 is connected to the bootstrap capacitor 9. The voltage regulation module 4 is configured to maintain the level of the first node Q.

With reference to FIG. 2, In an embodiment of the present invention, the forward and reverse scan control module 1 includes a first thin film transistor NT1 and a second thin film transistor NT2. A gate electrode of the first thin film transistor NT1 is connected to a gate electrode drive signal G(N−2) of a (N−2)th GOA unit, a source electrode of the first thin film transistor NT1 receives the forward direct current scan control signal U2D, a drain electrode of the first thin film transistor NT1 is connected to a source electrode of a seventh thin film transistor NT7 in the voltage regulation module 4 and a drain electrode of the second thin film transistor NT2; a gate electrode of the second thin film transistor NT2 is connected to a gate electrode drive signal G(N+2) of a (N+2)th GOA unit, and a source electrode of the second thin film transistor NT2 receives the reverse direct current scan control signal D2U.

The node signal control inputting module 2 includes a third thin film transistor NT3, a fourth thin film transistor NT4, and an eighth thin film transistor NT8. Agate electrode of the third thin film transistor NT3 receives the forward direct current scan control signal U2D, a source electrode of the third thin film transistor NT3 receives a clock signal CK(N+1) of a (N+1)th GOA unit, a drain electrode of the third thin film transistor NT3 is connected to a drain electrode of the fourth thin film transistor NT4 and a gate electrode of the eighth thin film transistor NT8; a gate electrode of the fourth thin film transistor NT4 receives the reverse direct current scan control signal D2U, and a source electrode of the fourth thin film transistor NT4 receives a clock signal CK(N−1) of a (N−1)th GOA unit; a source electrode of the eighth thin film transistor receives a constant voltage high potential signal VGH, a drain electrode of the eighth thin film transistor is connected to a second node P that is connected to the first node pull-down module 5, the second node pull-down module 6, the gate electrode signal pull-down module 7, and the global control signal function module 8. Potentials of the forward direct current scan control signal U2D and the reverse direct current scan control signal D2U are different at a same moment.

The output control module 3 includes a ninth thin film transistor NT9. A gate electrode of the ninth thin film transistor NT9 is connected to the first node Q, a source electrode of the ninth thin film transistor NT9 receives a present-stage clock signal CK(N), and a drain electrode of the ninth thin film transistor NT9 receives the present-stage gate electrode drive signal G(N).

The voltage regulation module 4 includes the seventh thin film transistor NT7. A gate electrode of the seventh thin film transistor NT7 receives a third global control signal GAS3, a source electrode of the seventh thin film transistor NT7 is connected to the forward and reverse scan control module 1 and the first node pull-down module 5, and a drain electrode of the seventh thin film transistor NT7 is connected to the first node Q. The third global control signal GAS3 is a constant voltage high level signal VGH during the touch panel scanning period, and is a constant voltage low potential signal VGL during the touch panel stop period.

The first node pull-down module 5 includes a fifth thin film transistor NT5. Agate electrode of the fifth thin film transistor NT5 is connected to the second node P, a source electrode of the fifth thin film transistor NT5 receives the constant voltage low potential signal VGL, and a drain electrode of the fifth thin film transistor NT5 is connected to the source electrode of the seventh thin film transistor NT7 of the voltage regulation module 4 and is connected to the first node Q through the seventh thin film transistor NT7.

The second node pull-down module 6 includes a sixth thin film transistor NT6. A gate electrode of the sixth thin film transistor NT6 is connected to the drain electrode of the first thin film transistor NT1 and the drain electrode of the second thin film transistor NT2 in the forward and reverse scan control module 1, a source electrode of the sixth thin film transistor NT6 receives the constant voltage low potential signal VGL, and a drain electrode of the sixth thin film transistor NT6 is connected to the second node P.

The gate electrode signal pull-down module 7 includes a tenth thin film transistor NT10. A gate electrode of the tenth thin film transistor NT10 is connected to the second node P, a source electrode of the tenth thin film transistor NT10 receives the constant voltage low potential signal VGL, and a drain electrode of the tenth thin film transistor NT10 is connected to the present-stage gate electrode drive signal G(N).

The global control signal function module 8 includes an eleventh thin film transistor NT11, a twelfth thin film transistor NT12, and a thirteenth thin film transistor NT13. A gate electrode and a source electrode of the eleventh thin film transistor NT1 are shorted for receiving the first global control signal, a drain electrode of the eleventh thin film transistor NT1 receives the present-stage gate electrode drive signal G(N). A gate electrode of the twelfth thin film transistor NT12 receives the first global control signal GAS1, a source electrode of the twelfth thin film transistor NT12 receives the constant voltage low potential signal VGL, and a drain electrode of the twelfth thin film transistor NT12 is connected to the second node P. A gate electrode of the thirteenth thin film transistor NT13 receives the second global control signal GAS2, a source electrode of the thirteenth thin film transistor NT13 receives the constant voltage low potential signal VGL, and a drain electrode of the thirteenth thin film transistor NT13 receives the present-stage gate electrode drive signal G(N).

The bootstrap capacitor 9 includes a first capacitor C1, one of two ends of the first capacitor C1 is connected to the constant voltage low potential signal VGL, the other end is connected to the first node Q and is connected to the drain electrode of the seventh thin film transistor NT7 in the voltage regulation module 4. The bootstrap capacitor 9 is configured to raise the level of the first node Q(N) two times.

In a conventional general GOA circuit, a touch panel stop leakage path exists. During a touch panel stop period, a potential of a third node O should maintain in a level of the constant voltage high level signal VGH. At the meantime, because the third node O has a leakage path of the fifth thin film transistor NT5 in the first node pull-down module 5, there is a risk of decrease of the level of the constant voltage high level signal VGH of the third node O, which results in failure of the GOA circuit during the touch panel stop period to further cause failure to open the ninth thin film transistor NT9 in the output control module 3 such that a next-stage GOA unit is unable to be opened.

To overcome the issue of an insufficient maintaining ability of the GOA circuit during stop of the touch panel and achieve a lowered risk of failure of stage transfer of the GOA circuit for enhanced stability of the GOA circuit, the present invention provides a design of improvement to the conventional GOA circuit. By improving a received signal of the seventh thin film transistor NT7 gate electrode in the voltage regulation module 4, i.e., a non-VGH third global control signal GAS3 changed from a constant voltage high level signal VGH, and by setting the voltage of the third global control signal GAS3 as a constant voltage low level signal VGL during the touch panel stop period to eliminate a touch panel stop leakage path. In other words, on the basis of the conventional GOA circuit, the gate electrode signal of the seventh thin film transistor is changed to a variable (or controllable) third global control signal, and a conventional third node (O point) storage capacitor is disposed on the drain electrode of the seventh thin film transistor NT7 of the voltage regulation module 4 (i.e., it becomes a first node Q). During the touch panel stop period, by changing a level of the third global control signal GAS3 in to a constant voltage low level signal VGL, the seventh thin film transistor NT7 is switched off to make a capacitor storing a potential of the constant voltage high level signal VGH of the first node Q broken from the third node O, as such, a leakage path from a potential of the constant voltage high level signal VGH of the first node Q to the fifth thin film transistor NT5 does not exist. At the same time, during a displaying period, because a level of the third global control signal GAS3 is consistent with the constant voltage high level signal VGH, normal work of the GOA during the touch panel scanning period will not be affected.

In the present embodiment, the thin film transistor in the GOA units is an N-type thin film transistor. Furthermore, a level of the constant voltage high level signal VGH is 10V, a level of the constant voltage low level signal VGL is −7V.

According to another aspect of the present invention, a display panel is provided, and the display panel includes the above GOA circuit. In other words, the GOA circuit has the same structures and connection relationships as included in the GOA circuit of the above embodiment, details of which refer to descriptions of the above embodiment and will not be described repeatedly.

The GOA circuit of the present invention, by changing the gate electrode signal of the seventh thin film transistor NT7 in the voltage regulation module 4 as a third global control signal GAS3 that is a constant voltage high potential signal, and by changing a voltage of the third global control signal GAS3 during the touch panel stop period as a constant voltage low potential signal, eliminates the touch panel stop leakage path to achieve a lowered risk of failure of stage transfer of the GOA circuit and to make the circuit more stable.

The above is only preferred embodiments of the present invention. It should be noted that a person of ordinary skill in the art can make several improvements and modifications without departing from the principle of the present invention. These improvements and modifications should also be considered to be within the scope of protection of the present invention.

Industrial Applicability

The subject matter of the present invention can be manufactured and used industrially and has industrial applicability.

1. A gate driver on array (GOA) circuit, wherein the GOA circuit comprises a plurality of GOA units that are cascaded, wherein when N is a positive integer greater than 2, an Nth stage GOA unit comprises: a forward and reverse scan control module, a node signal control inputting module, a first node pull-down module, a gate electrode signal pull-down module, a global control signal function module, an output control module, a voltage regulation module, and a bootstrap capacitor; wherein:
the forward and reverse scan control module is configured to control forward scan of the GOA circuit through a forward direct current scan control signal, or control reverse scan of the GOA circuit through a reverse direct current scan control signal; the node signal control inputting module is connected to the forward and reverse scan control module, the first node pull-down module, the gate electrode signal pull-down module, and the global control signal function module, the node signal control inputting module is configured to control low potential output of the GOA circuit; the first node pull-down module is connected to the forward and reverse scan control module, the node signal control inputting module, and the voltage regulation module, and the first node pull-down module is configured to pull down a level of the first node; the gate electrode signal pull-down module is connected to the node signal control inputting module and the output control module, and the gate electrode signal pull-down module is configured to pull down a level of a present-stage gate electrode drive signal and to control output of the present-stage gate electrode drive signal during a touch panel scanning period; the global control signal function module is connected to the node signal control inputting module, the gate electrode signal pull-down module, and the output control module, and the global control signal function module, by a first global control signal and a second global control signal, opens all of the gate electrode drive signal of the GOA circuit and controls the output of the present-stage gate electrode drive signal during the touch panel scanning period; the output control module is connected to the bootstrap capacitor, the global control signal function module, and the gate electrode signal pull-down module, and the output control module is configured to control of the output of the present-stage gate electrode drive signal; the voltage regulation module is connected to the forward and reverse scan control module, the first node pull-down module and the bootstrap capacitor, and the voltage regulation module is configured to maintain a level of a first node;
wherein the voltage regulation module comprises a seventh thin film transistor, and a gate electrode of the seventh thin film transistor receives a third global control signal, a source electrode of the seventh thin film transistor is connected to the forward and reverse scan control module and the first node pull-down module, a drain electrode of the seventh thin film transistor is connected to the first node, the third global control signal is a constant voltage high level signal during the touch panel scanning period, and is a constant voltage low potential signal during a touch panel stop period;
one of two ends of the bootstrap capacitor is connected to the drain electrode of the first node and the seventh thin film transistor, the other end receives the constant voltage low potential signal, and the bootstrap capacitor is configured to raise the level of the first node two times.

2. The GOA circuit as claimed in claim 1, wherein the Nth stage GOA unit further comprises: a second node pull-down module, the second node pull-down module is connected to the forward and reverse scan control module, the node signal control inputting module, and the first node pull-down module, and the second node pull-down module is configured to pull down a level of a second node.

3. The GOA circuit as claimed in claim 2, wherein the forward and reverse scan control module comprises a first thin film transistor and a second thin film transistor, a gate electrode of the first thin film transistor is connected to a gate electrode drive signal of a (N−2)th GOA unit, a source electrode of the first thin film transistor receives the forward direct current scan control signal, and a drain electrode of the first thin film transistor is connected to the source electrode of the seventh thin film transistor and a drain electrode of the second thin film transistor; a gate electrode of the second thin film transistor is connected to a gate electrode drive signal of a (N+2)th GOA unit, and a source electrode of the second thin film transistor receives the reverse direct current scan control signal.

4. The GOA circuit as claimed in claim 2, wherein the node signal control inputting module comprises a third thin film transistor, a fourth thin film transistor, and an eighth thin film transistor, a gate electrode of the third thin film transistor receives the forward direct current scan control signal, a source electrode of the third thin film transistor receives a clock signal of a (N+1)th GOA unit, and a drain electrode of the third thin film transistor is connected to a drain electrode of the fourth thin film transistor and a gate electrode of the eighth thin film transistor; a gate electrode of the fourth thin film transistor receives the reverse direct current scan control signal, and a source electrode of the fourth thin film transistor receives a clock signal of a (N−1)th GOA unit; a source electrode of the eighth thin film transistor receives a constant voltage high potential signal, and a drain electrode of the eighth thin film transistor is connected to a second node that is connected to the first node pull-down module, the second node pull-down module, the gate electrode signal pull-down module, and the global control signal function module.

5. The GOA circuit as claimed in claim 2, wherein the output control module comprises a ninth thin film transistor, a gate electrode of the ninth thin film transistor is connected to the first node, a source electrode of the ninth thin film transistor receives a present-stage clock signal, and a drain electrode of the ninth thin film transistor receives the present-stage gate electrode drive signal.

6. The GOA circuit as claimed in claim 2, wherein the first node pull-down module comprises a fifth thin film transistor, a gate electrode of the fifth thin film transistor is connected to the second node, a source electrode of the fifth thin film transistor receives the constant voltage low potential signal, a drain electrode of the fifth thin film transistor is connected to the source electrode of the seventh thin film transistor and is connected to the first node through the seventh thin film transistor.

7. The GOA circuit as claimed in claim 2, wherein the second node pull-down module comprises a sixth thin film transistor, a gate electrode of the sixth thin film transistor is connected to the drain electrode of the first thin film transistor and the drain electrode of the second thin film transistor in the forward and reverse scan control module, a source electrode of the sixth thin film transistor receives the constant voltage low potential signal, and a drain electrode of the sixth thin film transistor is connected to the second node.

8. The GOA circuit as claimed in claim 2, wherein the gate electrode signal pull-down module comprises a tenth thin film transistor, a gate electrode of the tenth thin film transistor is connected to the second node, a source electrode of the tenth thin film transistor receives the constant voltage low potential signal, and a drain electrode of the tenth thin film transistor receives the present-stage gate electrode drive signal.

9. The GOA circuit as claimed in claim 2, wherein the global control signal function module comprises an eleventh thin film transistor, a twelfth thin film transistor, and a thirteenth thin film transistor, a gate electrode, and a source electrode of the eleventh thin film transistor are shorted for receiving the first global control signal, and a drain electrode of the eleventh thin film transistor receives the present-stage gate electrode drive signal; a gate electrode of the twelfth thin film transistor receives the first global control signal, a source electrode of the twelfth thin film transistor receives the constant voltage low potential signal, and a drain electrode of the twelfth thin film transistor is connected to the second node; a gate electrode of the thirteenth thin film transistor receives the second global control signal, a source electrode of the thirteenth thin film transistor receives the constant voltage low potential signal, and a drain electrode of the thirteenth thin film transistor receives the present-stage gate electrode drive signal.

10. A display panel, comprising the GOA circuit as claimed in claim 1.
